(19) United States
(12) Patent Application Publication
(10) Pub. No.: US 2017/0168649 A1
(43) Pub. Date: Jun. 15, 2017

(54) VIBRATION PRESENTATION DEVICE

(71) Applicant: KABUSHIKI KAISHA TOKAI RIKA DENKI SEISAKUSHO, Aichi (JP)

(72) Inventor: Ikuko MIAYATA, Aichi (JP)

(21) Appl. No.: 15/367,625

(22) Filed: Dec. 2, 2016

(30) Foreign Application Priority Data
Dec. 10, 2015 (JP) 2015-241202

(51) Int. Cl. G06F 3/041; G06F 3/044; G06F 3/01

(52) U.S. Cl. CPC G06F 3/0418; G06F 3/016; G06F 3/044

(57) ABSTRACT

A vibration presentation device includes a detector configured to detect a tracing operation performed on an operating surface, a vibration applier configured to apply vibrations to the operating surface, an acceleration detector configured to detect acceleration associated with displacement of the operating surface, and a controller configured to discard an acceleration value detected by the acceleration detector during a period of vibration application in which the controller controls the vibration applier to apply vibrations to the operating surface.

The present application is based on Japanese patent application No. 2015-241202 filed on Dec. 10, 2015, the entire contents of which are incorporated herein by reference.

### TECHNICAL FIELD

The present invention relates to a vibration presentation device. BACKGROUND ART

In the conventional art, an input device is known that includes an electrostatic capacitance touch panel configured to output a touch detection signal when an electrostatic capacitance value increases via contact by an input means and exceeds a predetermined threshold, an acceleration sensor configured to detect and output acceleration applied to the touch panel via contact by the input means, and a controller configured to determine the presence or absence of contact by the input means via the output of the acceleration sensor (see for example Patent Document 1).

This input device can detect contact with the touch panel by the input means via the acceleration sensor.

### CITATION LIST

### Patent Literature

Patent Document 1: Japanese Unexamined Patent Application Publication No. 2013-109636A

### SUMMARY OF INVENTION

### Technical Problem

To-date, electronic devices are known that present vibrations to the operator through vibrations applied to the operating surface acting as operation feedback. In conventional touch panels that detect contact with the operating surface via an acceleration sensor, acceleration is detected while the vibrations are presented. This can lead to a false determination of operations associated with multiple contacts such as a double tap.

An object of the present invention is to provide a vibration presentation device with which occurrences of false determination of operations can be reduced.

### Solution to Problem

One aspect of the present invention is a vibration presentation device that includes a detector configured to detect a tracing operation performed on an operating surface, a vibration applier configured to apply vibrations to the operating surface, an acceleration detector configured to detect acceleration associated with displacement of the operating surface, and a controller configured to discard a value of acceleration detected by the acceleration detector during a period of vibration application in which the controller controls the vibration applier to apply vibrations to the operating surface.

### Advantageous Effects of Invention

According to the present invention, occurrences of false determination of operations can be reduced.

### BRIEF DESCRIPTION OF DRAWINGS

FIG. 1A is a schematic view of an example of a vehicle interior provided with a touch pad according to an embodiment.

FIG. 1B illustrates is an example of a block diagram of the touch pad.

FIG. 2A is a side view of an example of the configuration of the touch pad according to the embodiment.

FIG. 2B is a schematic view of an example of an icon and cursor displayed on a display device.

FIG. 2C is a graph showing examples of a vibration instruction signal, a drive signal, a displacement amount, and acceleration.

FIG. 3 is a flowchart illustrating an example of operations of the touch pad according to the embodiment.

### DESCRIPTION OF EMBODIMENTS

### Overview of Embodiments

A vibration presentation device according to the embodiments primarily includes a detector configured to detect a tracing operation performed on an operating surface, a vibration applier configured to apply vibrations to the operating surface, an acceleration detector configured to detect acceleration associated with displacement of the operating surface, and a controller configured to discard a value of acceleration detected by the acceleration detector during a period of vibration application in which the controller controls the vibration applier to apply vibrations to the operating surface.

The vibration presentation device discards the value of acceleration detected during the period of vibration application. Such a configuration can reduce occurrences of false determination caused by vibrations applied to the operating surface as operational vibrations compared to a configuration without such a vibration presentation device.

### Embodiments

### General Description of Touch Pad 1

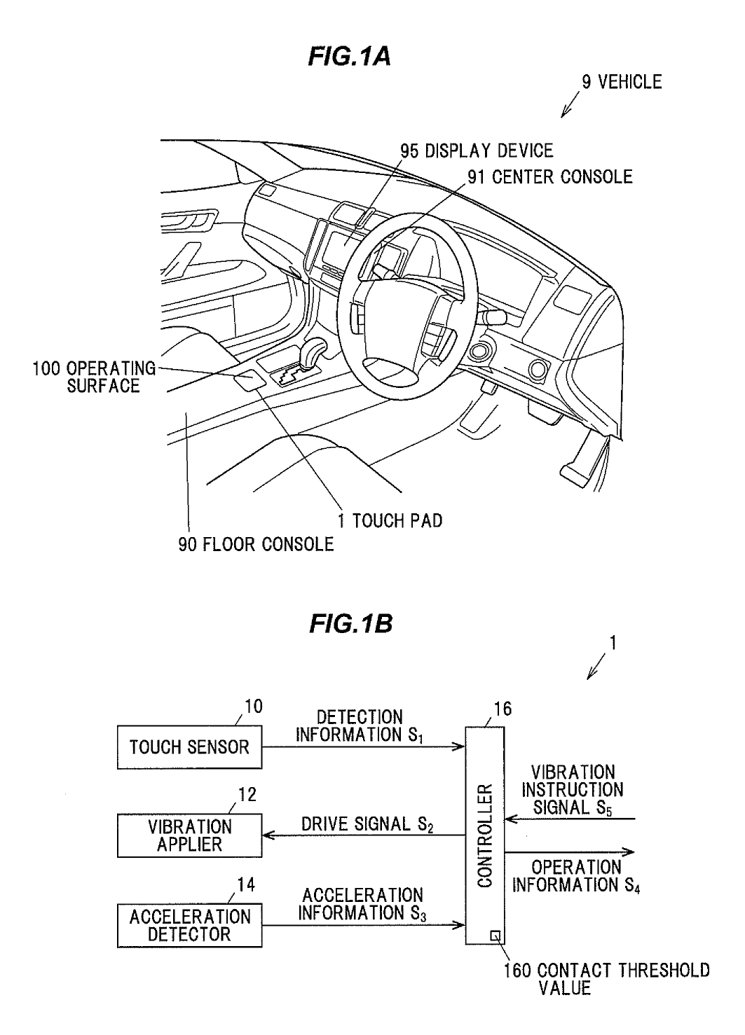

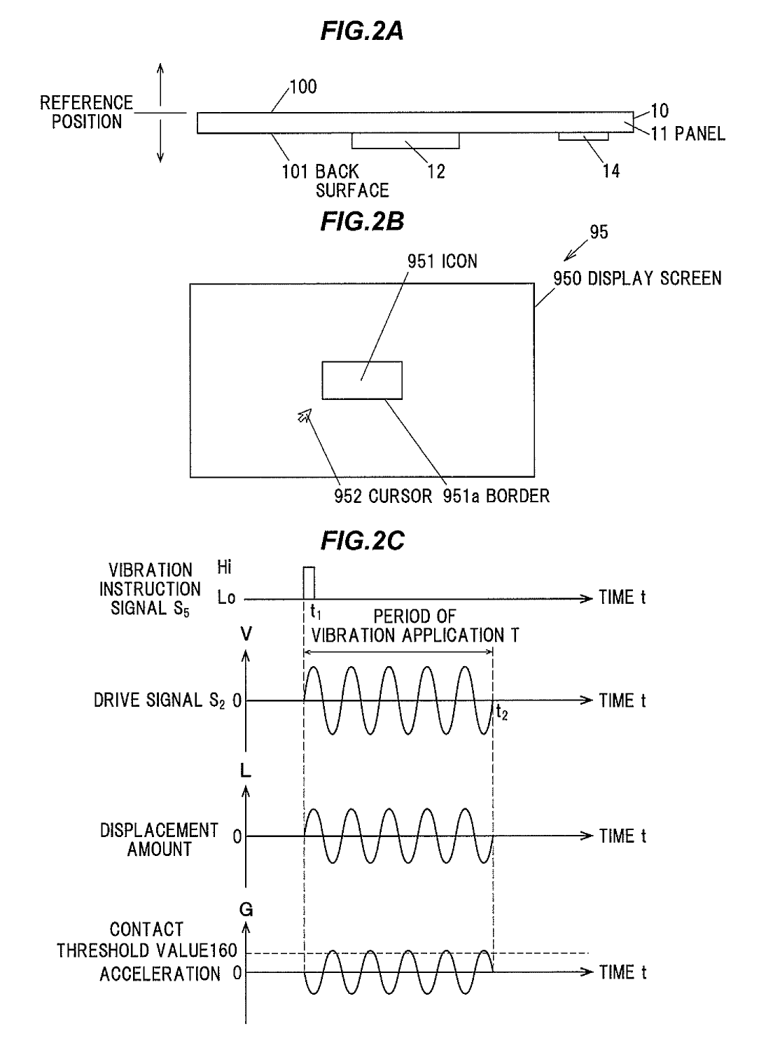

FIG. 1A is a schematic view of an example of a vehicle interior provided with a touch pad according to an embodiment. FIG. 1B illustrates an example of a block diagram of the touch pad. FIG. 2A is a side view of an example of the configuration of the touch pad according to the embodiment. FIG. 2B is a schematic view of an example of an icon and cursor displayed on a display device. FIG. 2C is a graph showing examples of a vibration instruction signal, a drive signal, a displacement amount, and acceleration. In FIG. 2C, the horizontal axis is time t. Additionally, in FIG. 2C, the vertical axis of the vibration instruction signal S₅ is Hi and Lo. The vertical axis of the drive signal S₂ is a drive voltage V. The vertical axis of the displacement amount is a displacement amount L from a reference position. The vertical axis of acceleration is detected acceleration G. In the drawings associated with the following embodiments, ratios between elements in the drawings may be different from the actual ratios. Additionally, in FIG. 1B, arrows indicate the flows of primary signals, information, and the like.

A touch pad 1 serving as a vibration presentation device is disposed in a floor console 90 that extends between a driver's seat and a passenger's seat of a vehicle 9, as illustrated in FIG. 1A, for example. The touch pad 1 functions as a remote operation unit for operating electronic devices installed in the vehicle 9. An operating surface 100 of the touch pad 1 is exposed from the floor console 90.

Examples of electronic devices include navigation devices, air conditioning devices, music playback devices, video playback devices, and the like. A display device 95 disposed in a center console 91 functions as a display for these electronic devices.

The touch pad 1, as illustrated in FIG. 1B and FIG. 2A, primarily includes a touch sensor 10 serving as a detector configured to detect tracing operations performed on the operating surface 100, a vibration applier 12 configured to apply vibrations to the operating surface 100, an acceleration detector 14 configured to detect acceleration associated with displacement of the operating surface 100, and a controller 16 configured to discard a value of acceleration detected by the acceleration detector 14 during a period of vibration application in which the controller 16 controls the vibration applier 12 to apply vibrations to the operating surface 100.

The touch sensor 10 detects tracing operations, touch operations, tap operations, double tap operations, flick operations, drag operations, pinch-in operations, pinch-out operations, and the like. Additionally, “value of acceleration” is referred to below as “acceleration value”.

The touch pad 1 as illustrated in FIG. 2B, for example, is configured so that, upon a cursor 952 reaching a border 951a of an icon 951 displayed on a display screen 950 of the display device 95, the touch pad 1 causes the operating surface 100 to vibrate so as to present feedback on the operation.

The operator feels this vibrations through an operating finger, thus being able to know that the icon 951 becomes selectable without looking at the display screen 950.

### Configuration of Much Sensor 10

The touch sensor 10, for example, is configured so that instructions such as movement of the cursor displayed on the display device 95 and selection, confirmation, dragging, dropping of the displayed icon can be performed by operations by a pen or operating finger having electrical conductivity. Below, the detection target of the touch sensor 10 is taken to be an operating finger.

A touch sensor able to detect at least tap operations such as a resistive film type, infrared type, surface acoustic wave (SAW) type, electrostatic capacitance type, and the like can be used as the touch sensor 10, for example.

The touch sensor 10 according to the present embodiment, for example, is an electrostatic capacitance type touch sensor configured to detect electrostatic capacitance between a detection electrode and an operating finger when the operating finger comes close to the operating surface 100. The detection electrode, for example, is disposed immediately below the operating surface 100 and is insulated in a first direction and a second direction that intersects the first direction.

The touch sensor 10, for example, calculates a detection point on the operating surface 100 where the operating finger has been detected from the detected electrostatic capacitance, generates detection information Si that includes information on the coordinates of the detection point, and outputs the detection information Si to the controller 16.

Note that the touch sensor 10, for example, if the electrostatic capacitance reaches or goes beyond the threshold value, calculates the detection point where the operating finger has been detected, but does not determine whether the operating finger is in contact with the operating surface 100. The determination as to contact is performed by the controller 16 on the basis of an acceleration value detected by the acceleration detector 14. The controller 16 determines that an operation has been performed by taking into account the detection result of the operating finger and the determination as to contact with the operating surface 100 based on the acceleration value.

The touch sensor 10, as illustrated in FIG. 2A for example, includes a plate-like panel 11. The front surface of the panel 11 corresponds to the operating surface 100. The detection electrode and the like described above are disposed on the back surface 101 side of the panel 11.

### Configuration of Vibration Applier 12

Specifically, the vibration applier 12, for example, is a monomorph piezoelectric actuator provided with a metal plate and a piezoelectric element. The monomorph piezoelectric actuator is an actuator having a structure which bends with only one piezoelectric element layer. Note that the vibration applier 12 is not limited to being a piezoelectric actuator and may be an eccentric motor that produces vibrations by rotating an eccentric mass, a voice coil motor, or the like. Additionally, the vibration applier 12 may include a plurality of piezoelectric actuators or the like.

The piezoelectric element described above, for example, expands or contract in accordance with the drive signal S₂ output from the controller 16. Note that the drive signal S₂, as illustrated in FIG. 2C for example, is a sine wave, but is not limited thereto.

The vibration applier 12 has a structure that produces vibrations via the metal plate bending in response to the piezoelectric element expanding or contracting. The vibrations displace the operating surface 100 up and down from the reference position illustrated in FIG. 2A. The graph in FIG. 2C schematically shows an example of the displacement amount L of the operating surface 100 from the reference position. Note that the operating surface 100, for example, is set as the reference position.

Examples of the material of the piezoelectric element include lithium niobate, barium titanate, lead titanate, lead zirconate titanate (PZT), lead metaniobate, polyvinylidene fluoride (PVDF), and the like. The piezoelectric element is, for example, a laminated piezoelectric element formed from layers of film made by these materials.

The vibration applier 12, as illustrated in FIG. 2A for example, is centrally disposed on the back surface 101 of the panel 11. The period of vibration application T (from time t₁ to time t₂), which is a period of time during which the vibration applier 12 applies vibrations, is 120 ms, for example.

### Configuration of Acceleration Detector 14

The acceleration detector 14, for example, is an optical type acceleration sensor, a semiconductor type acceleration sensor, or the like. The acceleration detector 14, as illustrated in FIG. 2A, for example, is disposed on the back surface 101 of the panel 11.

The acceleration detector 14, as illustrated in FIG. 2A, is configured to detect acceleration associated with displacement of the operating surface 100 from the reference position. The acceleration detector 14 generates acceleration information S₃ that includes information on a detected acceleration value, and outputs the acceleration information S₃ to the controller 16.

### Configuration of Controller 16

The controller 16 includes a contact threshold value 160 for determining contact by the operating finger with the operating surface 100, and is configured to perform typical determinations as well as to determine a multi-tap operation by the operating finger on the operating surface 100 by comparing the acceleration value detected by the acceleration detector 14 and the contact threshold value 160 after the period of vibration application described above. The multi-tap operation is a double tap operation, for example.

Specifically, the controller 16 is, for example, a microcomputer including a central processing unit (CPU) that carries out computations, processes, and the like on acquired data in accordance with a stored program; a random access memory (RAM) and a read only memory (ROM) that are semiconductor memories; and the like. A program for operations of the controller 16 and the contact threshold value 160 described above, for example, are stored in the ROM. The RAM is used as a storage region that temporarily stores computation results and the like, for example.

The controller 16 controls the vibration applier 12 in accordance with the vibration instruction signal S₅ input from a connected electronic device to apply vibrations to the operating surface 100. The controller 16, as illustrated in FIG. 2C for example, generates the drive signal S₂ when the vibration instruction signal S₅ changes from Lo to Hi and outputs the drive signal S₂ to the vibration applier 12 to apply vibrations to the operating surface 100. The period during which vibrations are applied is the period of vibration application T described above. The period of vibration application T is equivalent to the period from time t₁, when the vibration instruction signal S₅ is changed from Lo to Hi, to time t₂.

The contact threshold value 160 is a threshold value for determining whether or not the operating finger is in contact with the operating surface 100. The contact threshold value 160 is compared to the acceleration value detected by the acceleration detector 14. Upon the operating finger being in contact with the operating surface 100, a load is applied to the operating surface 100. This load causes displacement of the operating surface 100. The acceleration detector 14 detects acceleration G associated with this displacement. FIG. 2C shows an example of the contact threshold value 160.

The controller 16 determines that the operating finger is in contact with the operating surface 100 when the detected acceleration value is equal to or greater than the contact threshold value 160. Additionally, the controller 16, for example, generates operation information S₄, which includes information on the detection point where the contact operation on the operating surface 100 has been performed, when the touch sensor 10 detects the operating finger and the acceleration value equal to or greater than the contact threshold value 160 is detected. The operation information S₄ is output to a connected electronic device.

The controller 16, for example, determines that a tap operation has been performed when the touch sensor 10 detects the operating finger and a pulse-like acceleration value equal to or greater than the contact threshold value 160 is detected once, and determines that a double tap operation has been performed when a tap operation is detected twice in succession.

When the operating surface 100 vibrates up and down from the reference position, the acceleration detector 14 detects acceleration G corresponding to these vibrations, as shown in FIG. 2C. When the vibrations are large, the detected acceleration G is large and may become equal to or greater than the contact threshold value 160 despite the operating finger not being in contact with the operating surface 100.

In light of this, the controller 16, as described above, is configured to discard the acceleration value detected during the period of vibration application T.

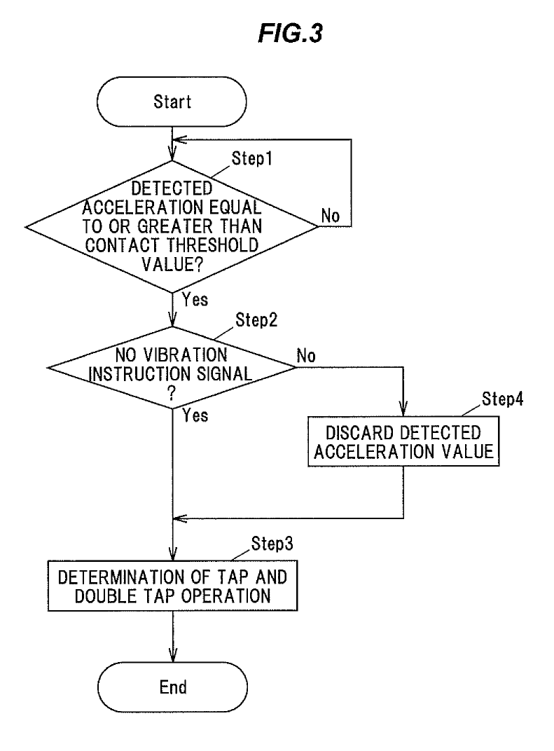

Examples of operations of the touch pad 1 of the present embodiment will be described below according to the flowchart illustrated in FIG. 3. Here, examples of operations up until determining whether to proceed to a determination of a tap and double tap operation will be explained. Determinations of other operations, for example, are performed after the determination of a tap and double tap operation.

### Operation

The controller 16 of the touch pad 1 acquires the detection information S₁ from the touch sensor 10 and acquires the acceleration information S₃ from the acceleration detector 14 when the power source of the vehicle 9 is on.

When “Yes” is true in Step 1, i.e. when the acceleration G based on the acceleration information S₃ is equal to or greater than the contact threshold value 160, (Step 1: Yes), the controller 16 verifies whether the vibration instruction signal S₅ has been input, i.e. whether the vibration instruction signal S₅ is Hi.

When no vibration instruction signal S₅ has been input, i.e. when the vibration instruction signal S₅ is Lo (Step 2: Yes), the controller 16 determines that the operating finger is in contact with the operating surface 100, proceeds to the determination of a tap and double tap operation (Step 3), and thus terminates the process up until this determination.

In Step 2, when the vibration instruction signal S₅ has been input, i.e. when the vibration instruction signal S₅ is Hi (Step 2: No), the controller 16 discards an acceleration value because the value has been detected during the period of vibration application T (Step 4), and proceeds to the process of Step 3.

### Effect of Embodiments

The touch pad 1 according to the present embodiments can reduce occurrences of false determination of operations. Specifically, the touch pad 1 discards the acceleration value detected by the acceleration detector 14 during the period of vibration application T, in which vibrations are applied, even when the acceleration value is equal to or greater than the contact threshold value 160. Such a configuration can reduce occurrences of false determination caused by vibrations applied to the operating surface 100 as operational vibrations compared to a configuration without such a touch pad 1. With touch pad 1, the correctness of the determination of tap and double tap operations can be improved.

Although several embodiments of the present invention have been described above, these embodiments are merely examples and the invention according to claims is not to be limited thereto. These novel embodiments may be implemented in various other forms, and various omissions, substitutions, changes, and the like can be made without departing from the spirit and scope of the present invention. In addition, all the combinations of the features described in these embodiments are not necessarily needed to solve the technical problem. Further, these embodiments are included within the spirit and scope of the invention and also within the invention described in the claims and the scope of equivalents thereof.

What is claimed is:

1. A vibration presentation device, comprising:
a detector configured to detect a tracing operation performed on an operating surface;
a vibration applier configured to apply vibrations to the operating surface;
an acceleration detector configured to detect acceleration associated with displacement of the operating surface; and
a controller configured to discard an acceleration value detected by the acceleration detector during a period of vibration application in which the controller controls the vibration applier to apply vibrations to the operating surface.

2. The device according to claim 1, wherein the controller includes a contact threshold value for determining contact by a detection target with the operating surface, and is configured to determine a multi-tap operation by the detection target on the operating surface by comparing the acceleration value detected by the acceleration detector and the contact threshold value after the period of vibration application.

3. The device according to claim 1, wherein the controller is configured to control the vibration applier in accordance with an input vibration instruction signal to apply vibrations to the operating surface.

4. The device according to claim 1, wherein the detector comprises an electrostatic capacitance type touch sensor.

5. The device according to claim 4, wherein the controller is configured such that a contact by a detection target with the operating surface is determined by the acceleration value detected by the acceleration detector except an electrostatic capacitance detected by the touch sensor.
